(19) United States
(12) Patent Application Publication
(10) Pub. No.: US 2025/0018662 A1
(43) Pub. Date: Jan. 16, 2025

(54) CARBON FIBER COMPRESSION MOLDED PARTS WITH FINISHED PAINTED SURFACES

(71) Applicant: GM GLOBAL TECHNOLOGY OPERATIONS LLC, Detroit, MI (US)

(72) Inventors: David A. Okonski, Waterford, MI (US); John Patrick Spicer, Plymouth, MI (US); Xiang Zhao, Novi, MI (US); Hua-tzu Fan, Troy, MI (US); Mary Gilliam, Farmington Hills, MI (US)

(21) Appl. No.: 18/352,051

(22) Filed: Jul. 13, 2023

(51) Int. Cl. B29C 70/38; B29C 70/34; B29C 70/54

(52) U.S. Cl. CPC B29C 70/38; B29C 70/345; B29C 70/54; B29K 2105/0872; B29K 2307/04

(57) ABSTRACT

A part formation system includes: a mobile robot; a first material feeding device configured to feed carbon fiber prepreg material, one layer at a time, onto the mobile robot to form a stack of carbon fiber prepreg layers on the mobile robot; a second material feeding device configured to feed a paint film onto the stack of carbon fiber prepreg layers to provide a resultant stack of layers; and a heat press configured to form and cure the resultant stack of layers to provide a resultant painted part by heating and compressing the resultant stack of layers.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to vehicular body panels and other painted parts, and more particularly to part forming and painting systems.

A vehicle typically includes multiple exterior body panels, such as quarter panels, fenders, roof panels, door panels, etc., having complex shapes and finished painted surfaces. The panels typically include multiple paint layers including basecoat layers and clearcoat layers. The paint layers provide a smooth and glossy finished outer exterior surface that is attractive to customers. The systems and processes for painting vehicle parts to provide an end product meeting stringent quality requirements are complex, intricate and costly.

### SUMMARY

A part formation system is disclosed and includes: a mobile robot; a first material feeding device configured to feed carbon fiber prepreg material, one layer at a time, onto the mobile robot to form a stack of carbon fiber prepreg layers on the mobile robot; a second material feeding device configured to feed a paint film onto the stack of carbon fiber prepreg layers to provide a resultant stack of layers; and a heat press configured to form and cure the resultant stack of layers to provide a resultant painted part by heating and compressing the resultant stack of layers.

In other features, the mobile robot is configured to rotate and adjust orientation of the carbon fiber prepreg layers when laid such that the carbon fiber prepreg layers are in different orientations relative to a material feed direction of the first material feed device.

In other features, the mobile robot includes a table. The table is configured, prior to each application of the carbon fiber prepreg material, to rotate and adjust orientation of a current stack of carbon fiber prepreg layers such that the carbon fiber prepreg layers of the stack of carbon fiber prepreg layers are laid in different orientations relative to a material feed direction of the first material feed device.

In other features, at least one of the mobile robot and a table of the mobile robot is configured to rotate such that at least one of the carbon fiber prepreg layers is in each of 0°, 45°, 90°, −45° orientations.

In other features, the part formation system further includes a laser cutter configured to cut each of the carbon fiber prepreg layers when laid and prior to another layer being stacked on that carbon fiber prepreg layer.

In other features, the part formation system further includes: one or more overhead cameras configured to detect a perimeter of one of the carbon fiber prepreg layers; a laser cutter; and a control module configured to control the laser cutter to cut another one of the carbon fiber prepreg layers or the paint film based on the detected perimeter.

In other features, the mobile robot is configured to adjust a height of a table of the mobile robot prior to the stacking of each one of the carbon fiber prepreg layers.

In other features, the part formation system further includes a gripper robot configured to pull at least one of the carbon fiber prepreg material and the paint film onto the mobile robot.

In other features, the part formation system further includes at least one of a stamper and a press configured, each time a respective one of the carbon fiber prepreg layers is stacked, to apply pressure to flatten and remove air below the respective one of the carbon fiber prepreg layers.

In other features, the part formation system further includes a roller configured, each time a respective one of the carbon fiber prepreg layers is stacked, to roll over and apply pressure on and remove air below the respective one of the carbon fiber prepreg layers.

In other features, the paint film includes a tie layer, the tie layer aiding in bonding the paint film to the stack of carbon fiber prepreg layers when heated and compressed in the heat press.

In other features, a method of forming a part is disclosed. The method includes: stacking a plurality of carbon fiber prepreg layers to form a first stack on a mobile robot; disposing a paint film on the first stack to provide a resultant stack; moving the resultant stack into a heat press; and heating and compression molding the resultant stack to provide the part having a painted surface as a result of heating and compressing the paint film along with the carbon fiber prepreg layers.

In other features, the method further includes: feeding via a first material feeding device in a first station layers of carbon fiber prepreg material, one layer at a time, onto the mobile robot to form the first stack on the mobile robot; moving the mobile robot from the first station to a second station; and feeding via a second material feeding device in the second station the paint film onto the first stack to provide the resultant stack.

In other features, the method further includes at least one of rotating the mobile robot or a table of the mobile robot to orient the carbon fiber prepreg layers in different orientations relative to a material feed direction of carbon fiber prepreg material used to form the carbon fiber prepreg layers.

In other features, the method further includes: pretreating a paint substrate of the paint film to provide a pretreated surface; applying one or more precursors across the pretreated surface of the paint film to deposit a tie layer; and disposing the paint film including the tie layer on the first stack prior to the resultant stack being placed in the heat press.

In other features, the method further includes applying an epoxy based thermoset layer on the tie layer; and disposing the paint film including the tie layer and the epoxy based thermoset layer on the first stack prior to the resultant stack being placed in the heat press.

In other features, at least one of the pretreating and the applying of the one or more precursors is implemented using atmospheric pressure plasma enhanced deposition.

In other features, the method further includes cutting each of the carbon fiber prepreg layers when laid and prior to another layer being stacked on that carbon fiber prepreg layer.

In other features, the method further includes: detecting a perimeter of one of the carbon fiber prepreg layers via one or more overhead cameras; and cutting another one of the carbon fiber prepreg layers or the paint film based on the detected perimeter.

In other features, the method further includes at least one of: each time a respective one of the carbon fiber prepreg layers is stacked, applying pressure to flatten and remove air below the respective one of the carbon fiber prepreg layers; and each time a respective one of the carbon fiber prepreg layers is stacked, rolling over and applying pressure on and removing air below the respective one of the carbon fiber prepreg layers.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 a side view of an example carbon fiber prepreg stacking station and an example paint film applying station including a mobile robot in accordance with the present disclosure;

FIG. 2 is a side view of the mobile robot including a stackup of layers and a heat press in accordance with the present disclosure;

FIG. 3 is a side view of the mobile robot of FIGS. 1-2;

FIG. 4 is a front view of the mobile robot of FIGS. 1-2;

FIGS. 5-7 are top views of different rotated orientations of the mobile robot of FIGS. 1-2;

FIG. 8A shows a side view of another example stacking station illustrating a laser cutter and overhead cameras in accordance with the present disclosure;

FIG. 8B is a top view of a stand of the stacking station of FIG. 8A;

FIG. 9 is a side view of an example layer stacking station illustrating examples of a stamping robot, a layer pulling robot, and a mobile robot including a vacuum pump in accordance with the present disclosure;

FIG. 10 is a side view of another example layer stacking station illustrating an example roller pressing robot in accordance with the present disclosure;

FIG. 11 a side view of an example carbon fiber prepreg stacking station and an example paint film applying station including another example mobile robot on a rail in accordance with the present disclosure;

FIG. 12 is a side view of the mobile robot of FIG. 11 including a stackup of layers and a heat press in accordance with the present disclosure;

FIGS. 13-15 are top views of different rotated orientations of a table of the mobile robot of FIGS. 11-12;

FIG. 16 is an example stack of layers of a part formed using the methods of FIGS. 20-21;

FIG. 17 is an example of two jets used to introduce a pretreatment gas and a precursor plasma to a paint substrate in accordance with the present disclosure;

FIG. 18 is a side cross-section view of an example jet that may be used to introduce one or more gases and/or plasma in accordance with the present disclosure;

FIG. 19 is a functional block diagram of a portion of an example part formation system in accordance with the present disclosure;

FIG. 20 is an example painted part formation method in accordance with the present disclosure; and

FIG. 21 is an example paint film formation method in accordance with the present disclosure.

In the drawings, reference numbers may be reused to identify similar and/or identical elements.

### DETAILED DESCRIPTION

Exterior body panels of a vehicle can be formed of a composite material. Composite body panels do not experience corrosion as do steel and aluminum body panels. Composite body panels can however have a long cycle time. The cycle time for a body panel includes time to layout, cut and stackup layers (or laminate plies) of the panel on a fixed table, time to heat, press, and cure the panel, and time to paint the panel. Each of the layers may be a carbon fiber epoxy (or prepreg) layer (referred to herein as a “carbon fiber prepreg layer”). The layers can be hand laid and oriented. Each layer may be laid in a different orientation (e.g., 0°, 45°, −45°, 90°, etc.) relative to the previously laid layer. The layers are laid in different orientations to increase strength of the body panel. The stack of layers is placed in an oven or autoclave and heated to cure the stack. Pressure is applied to stack during curing. The curing process can take 1-8 hours. Once cured, the body panel is then painted. The painting process can be time consuming and includes application of multiple layers including basecoat layers and clear coat layers.

The examples disclosed herein include automated stacking, orienting and cutting of carbon fiber prepreg layers, a tie layer, and paint film layers, and concurrently heating, pressing, and shaping the resultant stack of carbon fiber prepreg layers, tie layer, and paint film layers to form a part. The stacking, orienting, and cutting of the layers is quicker than the above-described hand laid process. Also, the paint film layers include paint material and when heated, pressed and shaped provide a finished painted surface without the need for a traditional paint booth with a painting system including paint spraying robots. The paint film layers are fast curing layers that cure along with the prepreg layers in less than 20 minutes. In an embodiment, the curing occurs in 3-5 minutes.

The examples introduce manufacturing processes and corresponding equipment and tools for producing high-strength, carbon fiber-based body panels and other parts that include finished paint surfaces, which satisfy stringent exterior paint surface requirements for vehicles. The finished painted surfaces can be free of scratches, blemishes, sags, etc. and satisfy gloss level and orange peel requirements. For example, the orange peel (or R-value) may be greater than 8.5. As an example, the paint finishes of this quality can be referred to as Class A paint surfaces. The processes for formation of a part include stacking multiple carbon fiber plies that are pre-impregnated with a fast-curing epoxy resin and fast curing compatible paint film layers. The layers may also include a tie layer disposed between the carbon fiber plies (or carbon fiber prepreg) layers and the paint layers. The tie layer aid in adhering the paint layers to the carbon fiber prepreg layers. An epoxy based thermoset layer may be applied to the tie layer and/or be disposed between the tie layer and the carbon fiber prepreg layers. The epoxy based thermoset layer may be included to further improve bonding between the tie layer and the carbon fiber prepreg layers. The resultant stack of layers is compression molded to form and cure the stack to provide a resultant part having the predetermined geometry and finished coating (e.g., painted surface with predetermined color, texture and gloss). The disclosed processes provide high-strength parts having three-dimensional shapes that can be assembled onto a vehicle without requiring subsequent painting.

The paint films used and processing conditions are selected to be compatible with carbon fiber and epoxy resin based layers arranged to provide a quasi-isotropic reinforced part. As used herein, a “quasi-isotropic” part refers to a part that has the same tensile modulus and tensile strength in multiple predetermined directions of concern. In one embodiment, a quasi-isotropic part formed has the same physical properties, such as the same tensile modulus and tensile strength, in two or more different directions. In another embodiment, a formed quasi-isotropic part has the same physical properties, such as the same tensile modulus and tensile strength, in 3-10 different directions. In another embodiment, a quasi-isotropic part formed has the same physical properties, such as the same tensile modulus and tensile strength, in any direction tested.

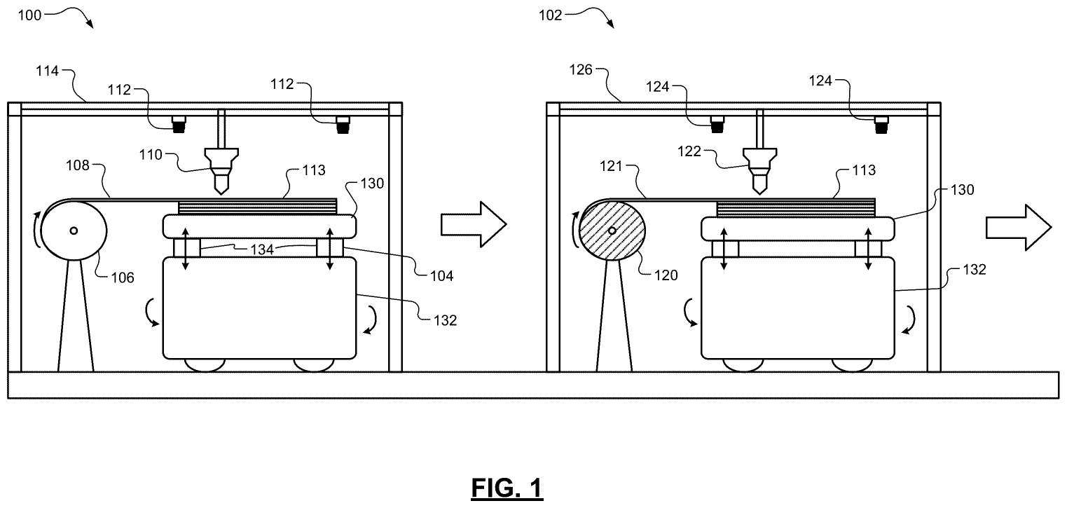

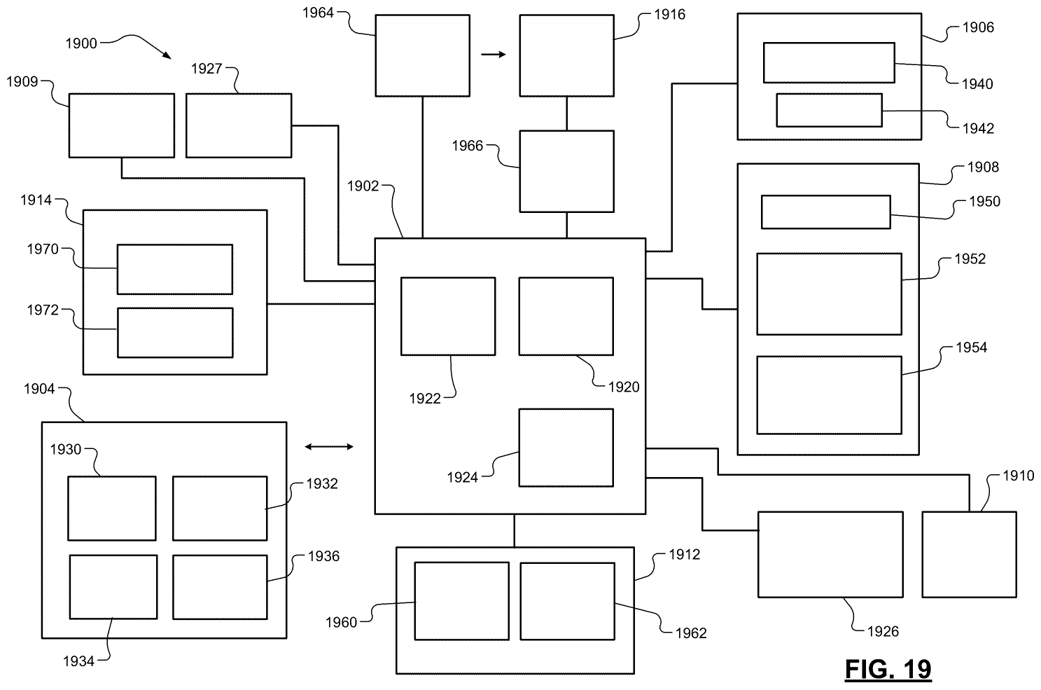

FIG. 1 shows a carbon fiber prepreg stacking station 100 and a paint film applying station 102 including a mobile robot 104. The mobile robot 104 is able to move from station-to-station, rotate about a Z axis of the robot and relative to a feed direction of material (e.g., carbon fiber prepreg material or paint film), and rotate relative to a laser cutter. The Z axis being a vertical axis. The mobile robot 104 may be an autonomous or partially autonomous robot and/or may be controlled by an onboard control module and/or a remotely located control module. Examples of these control modules are shown in FIG. 19.

The carbon fiber prepreg stacking station 100 includes a material feeding device 106 for feeding a layer of carbon fiber prepreg material 108 over the mobile robot 104. The material feeding device 106 may include rollers and motors for feeding the material 108. The carbon fiber prepreg stacking station 100 further includes an overhead laser cutter 110 and overhead cameras 112. The laser cutter 110 and the cameras 112 may be mounted on a stand 114. The stand 114 may include rails and/or actuators for moving the laser cutter 110 and cameras 112. A head of the overhead laser cutter 110 may move in X, Y and Z directions. Any number of layers may be stacked at this station. For example, 17-31 layers may be cut and stacked at this station. Each layer may be cut after the layer is laid on the stack 113.

The paint film applying station 102 includes a material feeding device 120 for feeding a paint film 121, which may include multiple paint film layers over the layer stack 113 on the mobile robot 104. The paint film is not a protective film for wrapping a painted body panel, but rather is a film with pigmented paint layers that is to be heated and cured concurrently with carbon fiber prepreg layers to provide the paint layers of the resulting finished part. The material feeding device 120 may include rollers and motors for feeding the paint film 121. The paint film applying station 102 further includes an overhead laser cutter 122 and overhead cameras 124. The laser cutter 122 and the cameras 124 may be mounted on a stand 126. The stand 126 may include rails and/or actuators for moving the laser cutter 122 and cameras 124. A head of the overhead laser cutter 122 may move in X, Y and Z directions. The paint film may be cut after the paint film is laid on the stack. In an embodiment, the material feeding devices 106, 120 are in a same station and the paint film 121 is applied in a same station as the carbon fiber prepreg layers.

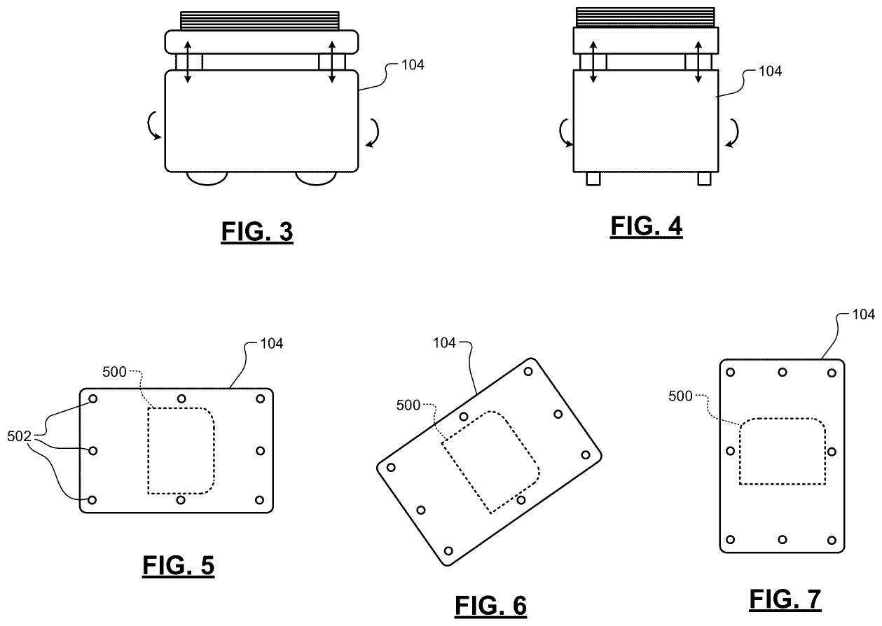

The mobile robot 104 has a table 130 that is able to move vertically relative to a base 132 via columns 134. This allows the top of the table 130 to be moved vertically relative to the material feeding devices 106, 120. As an example, after each layer of material is laid on the stack 113, the table 130 may move down a thickness of the material being laid. The mobile robot 104 is able to rotate to any angle relative to the material feed direction (referred to as the 0° position). The mobile robot 104 may be an omnidirectional drive robot. FIG. 3 shows a side view of the mobile robot 104 and FIG. 4 shows a front view of the mobile robot 104.

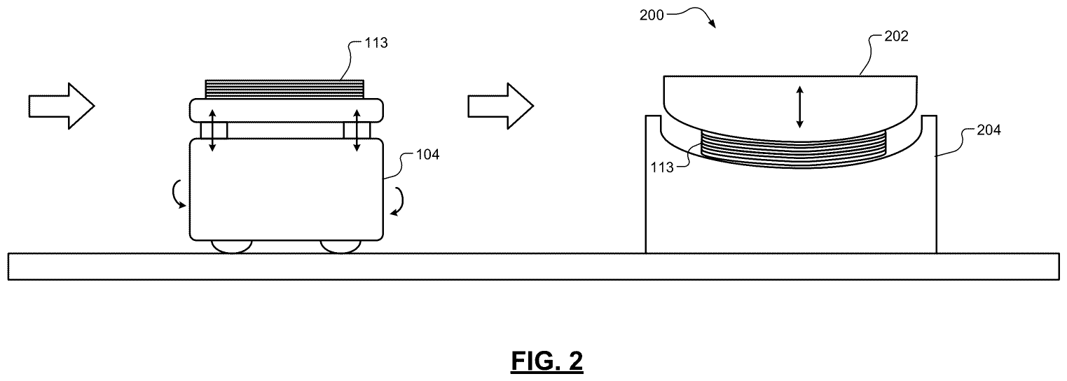

FIG. 2 shows the mobile robot 104 including the stack 113. The stack 113 includes the carbon fiber prepreg layers and the paint film. The mobile robot 104 may drive from the last station (e.g., the paint film applying station 102) to a heat press 200. The stack 113 is then moved from the mobile robot 104 and placed in the heat press 200. This may occur via another robot (not shown), manually, or via the mobile robot 104 if equipped with a robot arm for lifting and moving the stack off the mobile robot 104 and into the heat press 200.

The heat press 200 includes a top portion (or mold) 202 and a bottom portion (or mold) 204, which may include respective heaters. The stack 113 is placed between the portions 202, 204 and heated and compression molded to take the shape of the inner surfaces of the portions 202, 204. The process cures the stack 113 and the paint film when cured has a finished exterior surface satisfying painted surface requirements for that part. As an example, the stack 113 may be heated to 175° C.±10° C. and compressed at a pressure between 800-900 pounds-per-square inch (psi). In an embodiment, the stack 113 is heated to 175° C. This process may take less than 20 minutes. In one embodiment, this process is 3-5 minutes. In another embodiment, this process is 3 minutes.

FIGS. 5-7 show top views of different rotated orientations of the mobile robot 104. As an example, a stack 500 is shown cut in the shape of a ‘D’. The stack 500 and mobile robot 104 are shown in the 0°, 45° and 90° positions, but may be rotated to any angular position. The mobile robot 104 may have any number of reference points 502, which may be detected by overhead cameras (e.g., the cameras referred to herein). The location of the stack 500 is known and/or determined relative to the reference points 502. This enables precise cutting of each of the layers of the stack 500 when laid.

The mobile robot 104 rotates about the z-axis of the mobile robot 104 via omnidirectional driving motors of the mobile robot 104 to align the stack 500 on the table of the mobile robot 104 in a pre-defined orientation clockwise or counterclockwise. This is done to form meshes of carbon fibers stacked up at different angles for increased strength. In an embodiment, the mobile robot 104 is positioned at two different angles (0° and 90° or 45° and)−45°. For a first layer (or part substrate), a material layer is set on the table of the mobile robot 104 and cut using a laser cutter referred to herein. This is done based on a shape of the material layer (or part substrate) being cut (or part), dimensions of the material layer (or part), and know locations of the reference points 502 relative to material layer (or part). The material layer may be a first carbon fiber prepreg layer.

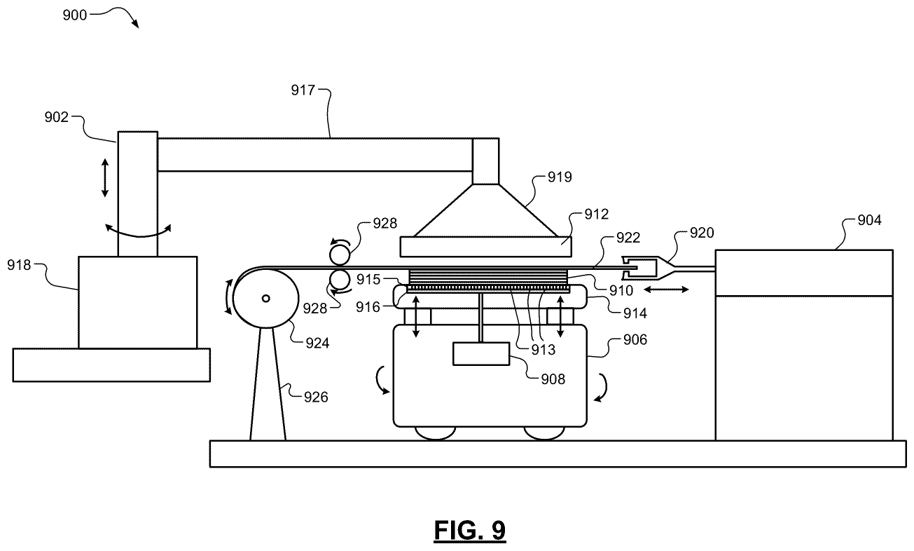

When there is one or more layers (or stack) on the table of the mobile robot 104, then vision cameras are used to detect the location and orientation of the stack on the mobile robot 104. The vision cameras are used to detect the perimeter including boundaries and/or edges of the stack to learn the cut path of the laser cutter. The laser cutter may follow the perimeter of a first and/or previous applied layer when cutting subsequent layers. These operations may be implemented by the control modules of FIG. 19. Each layer of the stack may be pulled over and laid on the table and/or existing stack using a pulling tool, device and/or robot. An example of a layer pulling robot is shown in FIG. 9.

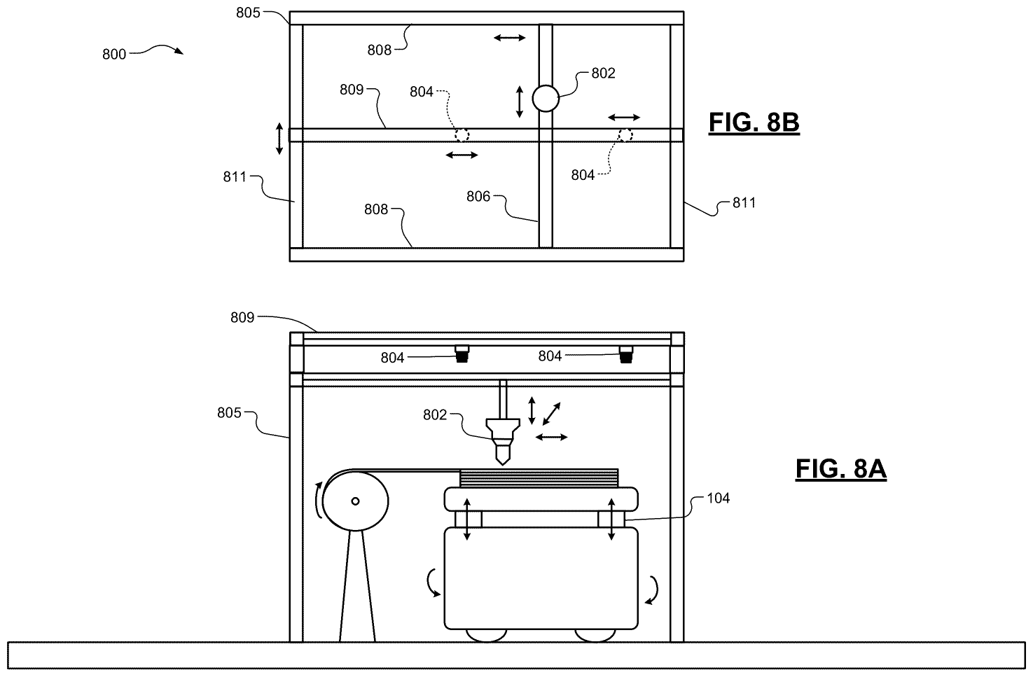

FIGS. 8A-8B show views of another example stacking station 800 illustrating a laser cutter 802 and overhead cameras 804, which are mounted on a stand 805. The laser cutter 802 may move in X and Y directions. The laser cutter 802 may move in the Y direction on a first rail 806. The first rail 806 may move in the X direction on a pair of rails 808, which moves the laser cutter 802 in the X direction. The laser cutter 802 is able to move relative to the mobile robot 104 in order to cut layers on the mobile robot 104. The cameras 804 are able to be moved in the X and Y directions along a beam 809 relative to the mobile robot 104 and/or angled to view layers and portions thereof on the mobile robot 104. The beam 809 may move laterally in the Y direction on a pair of rails 811. In one embodiment, the cameras 804 are able to view the layers and portions thereof without being moved. Any number of cameras may be included.

The laser cutter 802 is able to move in the X, Y, and Z directions. In the example shown, a roll of thermoset carbon fiber material or a paint film is fed in a unidirectional direction over the mobile robot 104 and cut using the laser cutter 802. The mobile robot 104 rotates between each applied layer to reorient the stack being created prior to application of the next layer. The height of the table is also moved (or indexed) between applications of consecutive layers.

FIG. 9 shows a layer stacking station 900 including a stamping robot 902, a layer pulling robot 904, and a mobile robot 906 including a vacuum pump 908. The stamping robot 902 stamps down on a stack 910 on the mobile robot 906 after each layer is applied to the stack 910 to remove air between layers and flatten the stack 910. The pressure applied to the stack 910 by the press arm plate 912 is low, for example, 25-50 psi.

To prevent the stack 910 and/or any layers thereof from sticking to the press arm plate 912, the press arm plate 912 may be formed of a non-stick material such as polytetrafluoroethylene (PTFE) and/or the mobile robot 906 may include the vacuum pump 908 that draws air through holes 913 in the table 914 of the mobile robot 906. This causes the stack 910 to be held to the table 914. The holes 913 may be distributed across the top plate 915 of the table 914 and be part of a manifold 916, which is connected to the vacuum pump 908. As another example and to prevent sticking, the bottom surface of the press arm plate 912 may be sprayed (or coated) with a release material such as calcium carbonate.

The stamping robot 902 may include an arm 917 that extends from a base 918 to the top plate assembly 919 and configured to rotate (or move) the top plate 915 over and away from the stack 910. This allows a laser cutter to cut applied layers without the top plate 915 being in the way of cutting. Although not shown in FIG. 9, an overhead laser cutter and overhead cameras may be included in the layer stacking station 900. The arm 917, top plate assembly 919 and top plate 915 are able to move vertically. The stamping robot 902 includes robots for moving the top plate vertically and for rotating the top plate to the stack 910 and away from the stack 910.

The layer pulling robot 904 includes a gripper 920 that extends in an opposite direction as a material feed direction, grabs material 922, and pulls the material over the stack 910. The material 922 is in a roll 924 of a material feeding device 926. The material 922 is fed via rollers 928 to the top of the mobile robot 906. The rollers 928 may be free rolling or attached to motors and turned via one of the control modules of FIG. 19. The mobile robot 906 may be similar to the mobile robot 104 of FIG. 1.

The material (e.g., composite material) is pulled by the gripper 920 over the stack 910. In an embodiment, the rollers 928 catch a cut edge of the material after the material has been cut off, and then presents the cut edge of the material to the gripper 920. The table 914 is raised or lowered depending upon whether another layer is being added to the current stack or a new stack is being formed. The table 914 is raised to an initial height when a new stack is to be formed and is lowered for each layer being applied. After a layer is applied, the layer is pressed with the press arm plate 912. The press arm plate 912 is then moved out of the way and the layer is cut using, for example, a laser cutter referred to herein. The laser cutter cuts off excess material. The table 914 may be rotated between application of each of the layers such that the carbon fibers and/or carbon fiber arrays of each layer are at different angles. Two or more of the layers may be arranged at the same angle. In one embodiment, a predetermined pattern of orientations is provided by a first set of layers and then repeated for a next set of layers in a same stack of layers.

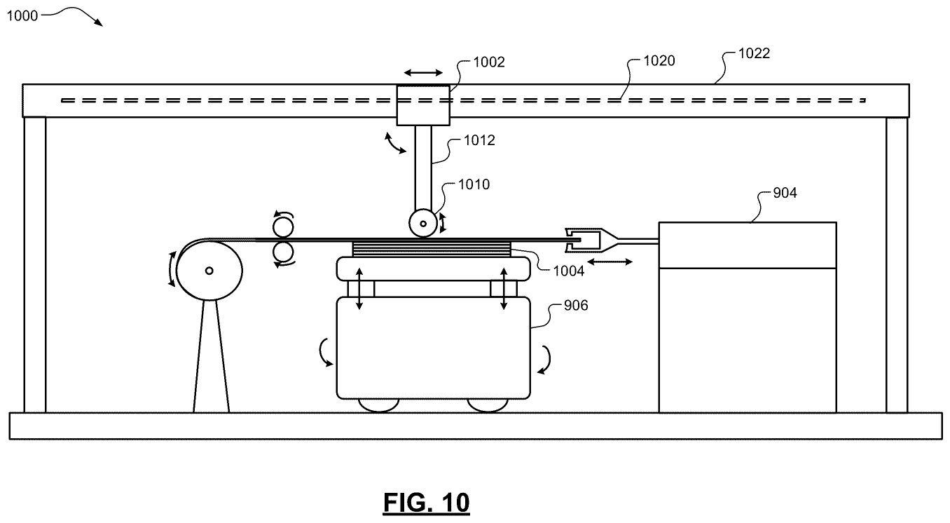

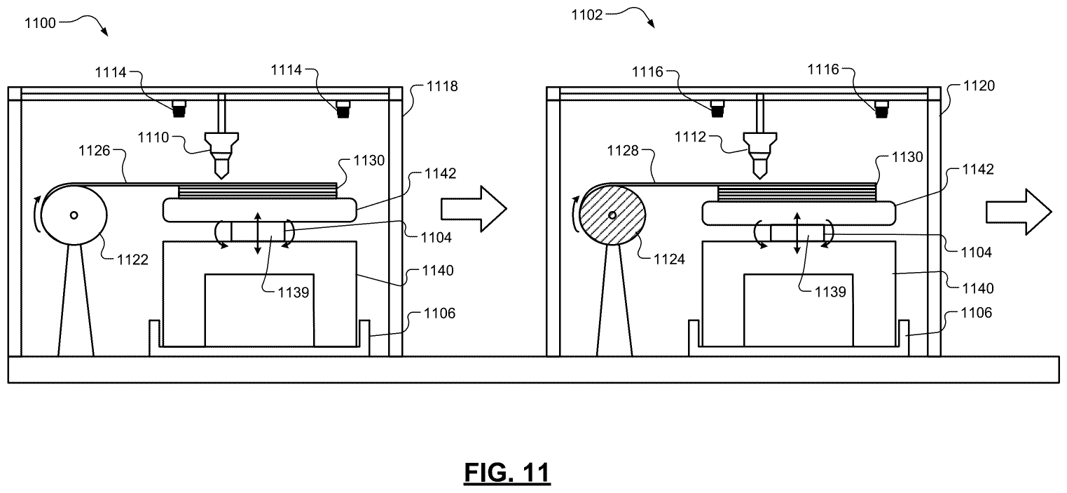

FIG. 10 shows a layer stacking station 1000 that includes the layer pulling robot 904, the mobile robot 906, and a roller pressing robot 1002. The roller pressing robot 1002 applies pressure on and rolls across a top surface of a stack 1004 on the mobile robot 906. This may occur after each layer is applied to the stack 1004 to remove air between layers and flatten the stack 1004. The pressure applied to the stack 1004 is low, for example, 25-50 psi. The roller pressing robot 1002 includes a roller 1010 and an arm 1012. The arm 1012 may be rotated, as shown, or may move vertically to apply pressure via the roller 1010 on the stack 1004. The roller pressing robot 1002 may move in X and Y directions via overhead rails 1020 on a stand 1022. The roller pressing robot 1002 may be used instead of the stamping robot 902 of FIG. 10.

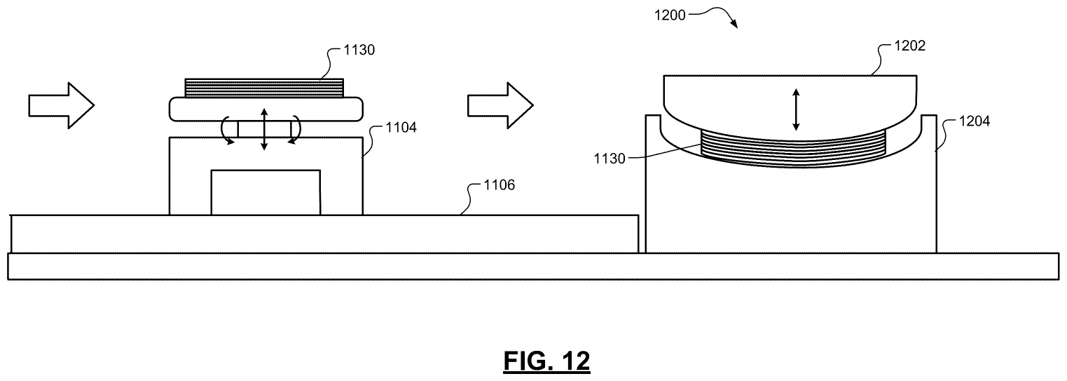

FIG. 11 shows a carbon fiber prepreg stacking station 1100 and an example paint film applying station 1102 including another example mobile robot 1104 on a rail 1106. The stations 1100, 1102 may include laser cutters 1110, 1112 and cameras 1114, 1116 that are mounted and/or hang from stands 1118, 1120. Material feeding devices 1122, 1124 feed carbon fiber prepreg material 1126 and paint film 1128 to be applied to a stack 1130.

The mobile robot 1104 includes a base 1140 and a table 1142 that moves vertically via column 1139 and rotates relative to the base 1140. The table 1142 rotates about a Z axis of the mobile robot 1104. The base moves along the rail 1106. Although, not shown, the mobile robot 1104 may move along the rail 1106 from station to station and from station to heat press. An example heat press is shown in FIG. 12. As an example, the mobile robot 1104 may move in the X direction from station to station and from station to heat press. The mobile robot 1104 may be an autonomous or semi-autonomous robot.

FIG. 12 shows the mobile robot 1104 of FIG. 11 including the stack 1130 and a heat press 1200. The mobile robot 1104 moves along the rail 1106 from a previous station (e.g., the paint film applying station 1102) to the heat press 1200.

The heat press 1200 includes a top portion (or mold) 1202 and a bottom portion (or mold) 1204, which may include respective heaters. The stack 1130 is placed between the portions 1202, 1204, heated and compression molded to take the shape of the inner surfaces of the portions 1202, 1204. The process cures the stack 1130. The paint film when cured has a finished exterior surface satisfying painted surface requirements for that part. As an example, the stack 1130 may be heated to 175° C.±10° C. and compressed at a pressure between 800-900 psi. In an embodiment, the stack 1130 is heated to 175° C. This process may take less than 20 minutes. In one embodiment, this process is 3-5 minutes. In another embodiment, this process is 3 minutes.

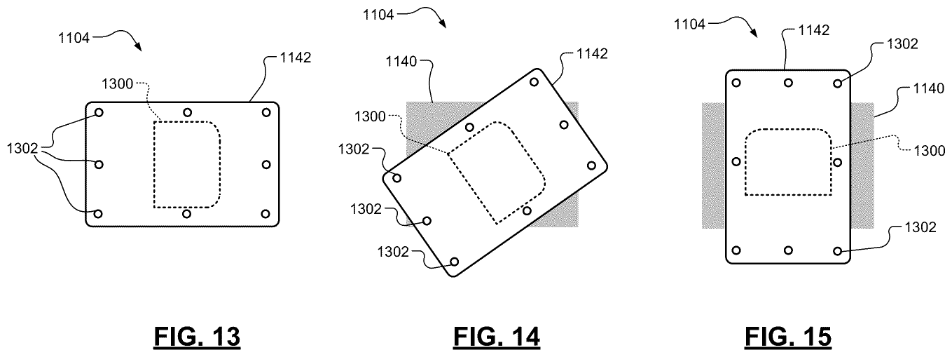

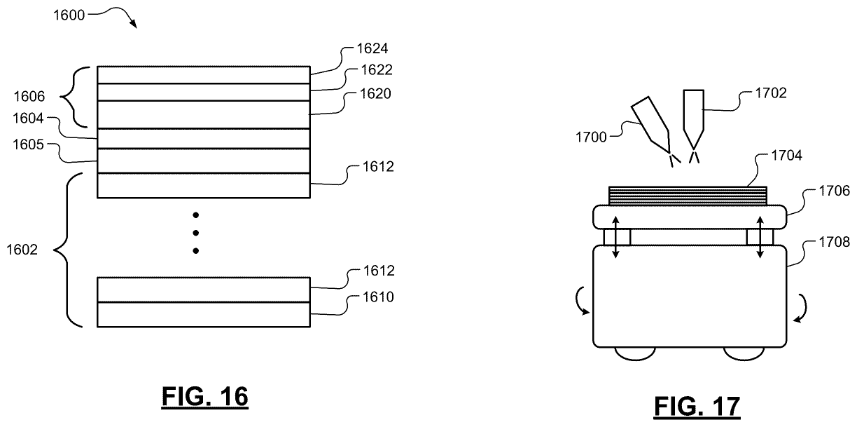

FIGS. 13-15 show different rotated orientations of the table 1142 of the mobile robot 1104. As an example, a stack 1300 is shown cut in the shape of a ‘D’. The stack 1300 and table 1142 are shown in the 0°, 45° and 90° positions, but may be rotated to any angular position relative to the base 1140. The table 1142 may have any number of reference points 1302, which may be detected by overhead cameras (e.g., the cameras referred to herein). The location of the stack 1300 is known and/or determined relative to the reference points 1302. This enables precise cutting of each of the layers of the stack 1300 when laid.

The table 1142 rotates about the z-axis via a motor of the mobile robot 1104 to align the stack 1300 on the table 1142 in a pre-defined orientation clockwise or counterclockwise. This is done to form meshes of carbon fibers stacked up at different angles for increased strength. In an embodiment, the table 1142 is positioned at two different angles (0° and 90° or 45° and)−45°. For a first layer (or part substrate), a material layer is set on the table 1142 and cut using a laser cutter referred to herein based on a shape of the material layer (or part substrate) being cut, dimensions of the material layer, and know locations of the reference points 1302 relative to the material layer. The material layer may be a first carbon fiber prepreg layer.

When there is one or more layers (or stack) on the table 1142, then vision cameras are used to detect the location and orientation of the stack on the mobile robot 1104. The vision cameras are used to detect the perimeter including boundaries and/or edges of the stack to learn the cut path of the laser cutter. The laser cutter may follow the perimeter of a first and/or previous applied layer when cutting layers other than the first layer. These operations may be implemented by the control modules of FIG. 19. Each layer of the stack may be pulled over and laid on the table and/or existing stack using a pulling tool, device and/or robot. An example of a layer pulling robot is shown in FIG. 9.

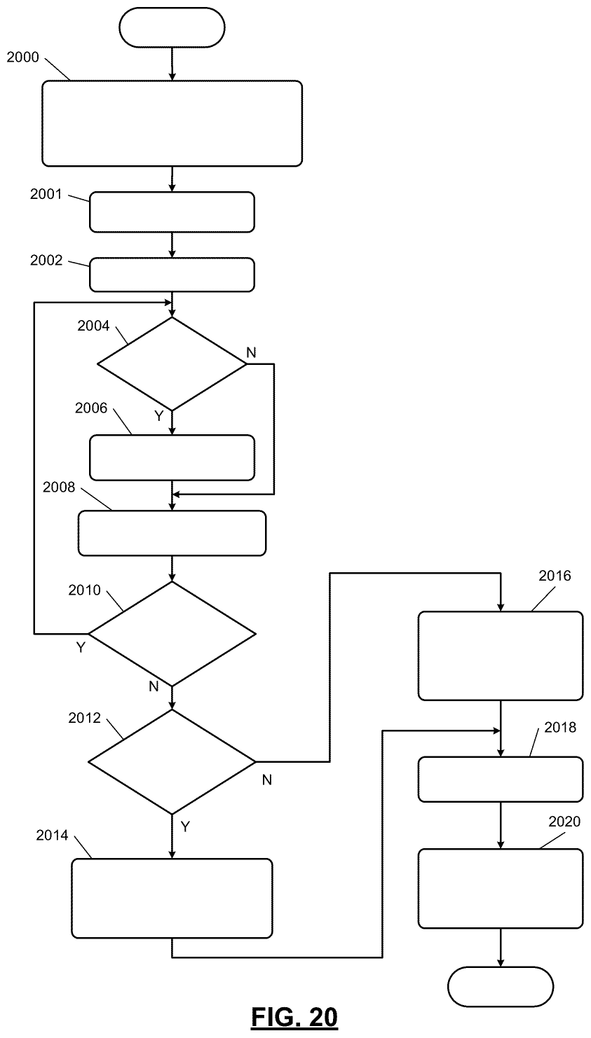

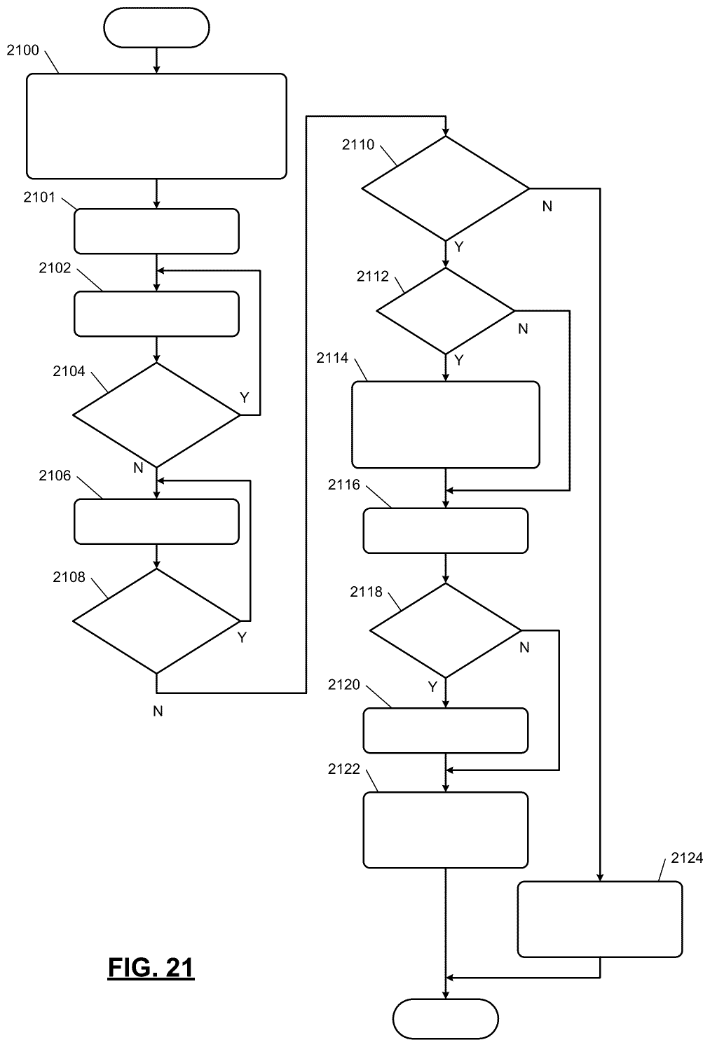

FIG. 16 shows an example stack 1600 of layers of a part formed using the methods of FIGS. 20-21. The stack 1600 includes base support layers 1602, a tie layer 1604, an epoxy based thermoset layer 1605, and paint film layers 1606 of a paint film. The base support layers 1602 may include a part substrate 1610 and one or more carbon fiber prepreg layers 1612. The part substrate 1610 may be a carbon fiber prepreg layer or other substrate support layer. As an example, the carbon fiber prepreg layers 1610, 1612 may have a tensile modulus of 30-70 gigapascals (GPA). Resin(s) and carbon fiber of the carbon fiber prepreg layers 1610, 1612 are selected and orientations of the carbon fiber prepreg layers 1610, 1612 are selected to provide a target tensile modulus. In an embodiment, at least some of the carbon fiber prepreg layers 1610, 1612 may be oriented in the 0°, 90°, 45°, −45° orientations about a corresponding z-axis (or vertical axis). In an embodiment, 17-31 carbon fiber prepreg layers are stacked for a total overall panel thickness of 2-3 mm to provide a corresponding target panel strength. The carbon fiber prepreg layers 1610, 1612 may include material with epoxy based chemistries.

A bottom portion of the paint substrate 1620 is pretreated prior to forming the tie layer 1604, which is a thin film having a thickness of less than 1 micron. Precursors are introduced to the pretreated portion of the paint substrate 1620 to form the tie layer 1604. The epoxy based thermoset layer 1605 may be applied to the bottom of the tie layer 1604. In an embodiment, the epoxy based thermoset layer 1605 is not included. The epoxy based thermoset layer 1614 may include material with epoxy-based chemistries.

The paint film may be a thermoplastic laminate paint film that includes a paint substrate 1620, one or more basecoat layers 1622, and one or more clearcoat layers 1624. In an embodiment, the paint substrate 1620 is made chemically compatible with the thermoset carbon fiber reinforced plies (or layers 1612) via pretreatment and formation of the tie layer 1604 As an example, the paint substrate 1620 may include fluorocarbon polymers, polypropylene, or other suitable materials. The paint substrate 1620 may be a polymeric film. The basecoat layers 1622 may be pigmented basecoat layers. The layers 1622 and 1624 are resilient to a predetermined strain rate and predetermined maximum amount of strain. One or more of the paint film layers 1606 may include conductive elements such as a metal mesh and/or metal particles to provide one or more conductive layers. In an embodiment, the conductive layers are formed for lightning strike protection that may be experienced by an exterior of a vehicle (e.g., automotive vehicle or aircraft vehicle). The metal mesh and metal particles may be formed of copper and/or other conductive material.

The layer 1604 improves bonding of the paint film layers 1606 to the carbon fiber prepreg layers 1612. The tie layer 1604 is formed and/or bonded to the paint substrate 1620 prior to the paint film being applied to the carbon fiber prepreg layers 1612. The tie layer 1604 is formed prior to compression molding of the stack 1600. The tie layer 1604 is formed using an in-line deposition process that does not require a curing step. The tie layer 1604 is applied under atmospheric pressure using atmospheric pressure plasma enhanced deposition. This plasma process may be performed for at least one of pretreatment and precursor deposition.

A bottom surface of the paint substrate 1620 is pretreated with plasma in preparation for deposition of one or more precursor to form the tie layer 1604. The pretreatment is conducted to change surface energy and oxidize the surface of the paint substrate 1620 to improve adherence of the deposited tie layer 1604 to the paint substrate 1620. The plasma includes a non-depositing gas, such as air, nitrogen, argon, hydrogen, oxygen, or water vapor. The tie layer 1604 is then formed by introducing one or more chemical precursors that deposit a thin film (e.g., less than a micron thick) containing functional groups on a bottom surface of the pretreated portion of the paint substrate 1620. The functional groups are reactive with the compounds in the fast-cure thermoset resin of the epoxy based thermoset layer 1605 and/or the carbon fiber prepreg layers 1612. This reaction provides strong adhesive forces, such as covalent bonding, hydrogen bonding, mechanical interlocking, etc. The chemical precursors may include chemicals containing organic groups, such as epoxides, amines and other nitrogen compounds, ethers, carbonyl compounds, and hydroxyls. The chemical precursors may include organic-metal hybrid compounds, such as organosilanes, alkoxysilanes, and hydrolyzed metal-compounds containing organic groups. As an example, a total overall thickness of the tie layer may be less than 300 nanometers (nm). The precursors enhance adherence of the paint film to the carbon fiber prepreg layers 1612.

The pretreatment and/or the formation of the tie layer 1604 may be formed using a plasma process including plasma jets, where each jet is a single source of plasma. An array of jets may be used. The jets may scan surfaces to be treated and/or surfaces on which material is to be deposited. The tie layer 1604 may be formed with the paint film layers 1606 upside down on a table, such that the tie layer 1604 may be formed on the bottom surface of the paint substrate 1620. In an embodiment, the jet array scans the surfaces using pulsed direct current (DC) or alternating current (AC) in a range of 20 kilohertz (kH) to 300 gigahertz (GHz). In another embodiment, a dielectric barrier discharge (DBD) plasma configuration is used.

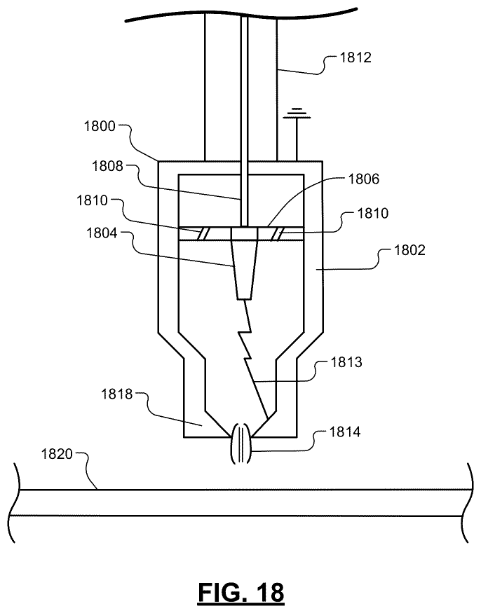

FIG. 17 shows an example implementation including the use of two jets 1700, 1702. The first jet 1700 may be used to introduce a pretreatment gas and/or plasma. The second jet 1702 may be used to introduce a precursor plasma. The jets 1700, 1702 may be scanned (moved in X and Y directions) across a stack of layers 1704 on a table 1706 of a mobile robot 1708. An example configuration that may be used for each of the jets 1700, 1702 is shown in FIG. 18.

FIG. 18 shows a jet 1800 that may be used to introduce a gas and/or plasma. The jet 1800 includes an outer housing 1802, an electrode 1804, and a central member 1806. The electrode 1804 is mounted on the central member 1806 and receives power via line 1808. The central member 1806 includes holes 1810 for passage of gas received via intake member 1812. The power may be DC and/or AC power. The housing 1802 may be grounded. The electrode 1804 is used to generate an electrical arc 1813 between the electrode 1804 and the housing 1802 to form plasma 1814, which is output from a venturi nozzle 1818 of the jet 1800. The plasma is directed at a surface of layer 1820 being treated.

FIG. 19 shows a portion 1900 of a part formation system that may include any of the robots, systems, components, devices, etc. of FIGS. 1-15 and 17-18. In the shown example of FIG. 19, the portion 1900 includes a control station 1902, a mobile robot 1904, a heat press 1906, material feeding devices 1908, laser cutter 1909, cameras 1910, a layer pulling robot 1912, pressing robot 1914, and jets 1916.

The control station 1902 may include a control module 1920, a transceiver 1922 and a memory 1924. The control module 1920 may communicate with the mobile robot 1904 via the transceiver 1922. The control module 1920 may also control the mobile robot 1904 and/or provide instructions, requested settings and/or parameters to the mobile robot 1904. The control module 1920 may also control and/or provide instructions, requested settings and/or parameters to the heat press 1906, material feeding devices 1908, laser cutter 1909, camera motors and actuators 1926, and/or robots 1912, 1914. The laser cutter 1909 is moved by motors 1927. This may include moving a beam on which the laser cutter 1909 is mounted. The camera motors and actuators 1926 move the cameras 1910 in X and Y directions and angle the cameras 1910. This may include moving a beam on which the cameras are mounted. The memory 1924 may store algorithms, instructions, parameters, stackup layer orientations, stackup layer orders, tie layer recipes, paint layer recipes, and/or other related information.

The mobile robot 1904 may include a control module 1930, a transceiver 1932, a pump 1934, and motors 1936. The control module 1930 may control the pump 1934 and motors 1936. The motors 1936 may include motors for raising, lowering and rotating a table, such as one of the tables referred to herein. The motors 1936 may also include motors for moving and/or rotating the mobile robot 1904 in X and Y directions. The pump 1934 may be used to hold layers stacked on the table.

The heat press 1906 may include one or more high-pressure pressing motors 1940 for compressing and forming a stack of layers and one or more heaters 1942 for curing the stack of layers. The material feeding devices 1908 may include roller motors 1950, carbon fiber prepreg feed motors 1952, and paint film feed motors 1954. The cameras 1910 may be moved and/or oriented via the camera motors and actuators 1926.

The layer pulling robot 1912 may include one or more gripper motors 1960 and one or more material pulling motors 1962. The gripper motors 1960 may actuate one or more grippers to grab material to be, for example, pulled over at least a portion of the table of the mobile robot 1904. The pressing robot 1914 may include a one or more low-pressure press motors 1970 and/or other actuation motors 1972 for moving portions of the robot 1914. The low-pressure press motors 1970 may be used to stamp and/or apply a low amount of pressure to a stack after a layer is applied, as described above. The low-pressure press motors 1970 may move a stamping plate or a pressing roller in a Z direction and/or in an angular motion. The actuation motors 1972 may be used to move a stamping plate or a pressing roller in X and Y directions.

The jets 1916 receive gases from a gas supply system 1964 and supply gases and/or plasma towards a paint film to form tie layers on the paint film prior to the paint film being disposed on carbon fiber prepreg layers stacked on the table of the mobile robot 1904. The jets 1916 may receive power from a power source 1966, which may be controlled by the control module 1920.

The following FIGS. 20-21 may be implemented by the part formation system of FIG. 19. FIG. 20 shows a painted part formation method for formation of a painted part (e.g., a vehicle body panel). At 2000, the control module 1920 of FIG. 19 may determine part makeup including quantities of each layer, orientations of the layers, order of layers in a stack, types of layers, layer makeups, recipes, etc.

At 2001, one or more of the control modules 1920, 1930 orients the mobile robot 1904 and/or the table of the mobile robot 1904 prior to forming a part substrate. At 2002, the part substrate is formed. This may include disposing material for the part substrate on the table of the mobile robot 1904. The part substrate may be a first carbon fiber prepreg layer. The material may be cut (i.e., dimensioned) according to a predetermined set pattern, which may have been determined at 2000. The part substrate may be stamped or pressed.

At 2004, one or more of the control modules 1920, 1930 determines whether to reorient the mobile robot 1904 and/or the table for the next layer. If yes, operation 2006 is performed, otherwise operation 2008 is performed.

At 2006, one or more of the control modules 1920, 1930 reorients the mobile robot 1904 and/or the table. At 2008, one or more of the control modules 1920, 1930 applies a carbon fiber prepreg layer to the stack.

At 2010, one or more of the control modules 1920, 1930 determines whether another carbon fiber prepreg layer is to be formed. If yes, the stack of carbon fiber prepreg layers has been formed and operation 2004 is performed, otherwise operation 2012 is performed.

At 2012, one or more of the control modules 1920, 1930 determines whether to apply a paint film with a tie layer. If yes, operation 2014 is performed, otherwise operation 2016 is performed.

At 2014, one or more of the control modules 1920, 1930 applies the tie layer to the paint film and stacks the paint film with the tie layer on the formed stack of carbon fiber prepreg layers to provide a resultant stack. At 2016, one or more of the control modules 1920, 1930 stacks the paint film without tie layer on the formed stack of carbon fiber prepreg layers to provide a resultant stack.

At 2018, the resultant stack is placed in a heat press. At 2020, the resultant stack is heated and compressed as described above to form and cure the resultant stack into a finished part having a finished paint finish. The method may end subsequent to operation 2020.

FIG. 21 shows a paint film formation method, which may be performed prior to and/or during operations 2012, 2014, and 2016 of FIG. 20. At 2100, may determine paint film and tie layer makeups including quantities of each layer, orientations of the layers, order of layers in a stack, types of layers, recipes for tie layers, etc. The recipes may include materials, temperatures, gas and/or plasma application pressures and durations, voltages, etc.

At 2101, the control module 1920 may control formation of a paint substrate. At 2102, the control module 1920 applies a basecoat layer to the paint substrate.

At 2104, the control module 1920 may determine whether another basecoat layer is to be applied. If yes, operation 2102 is performed, otherwise operation 2106 is performed. At 2106, the control module 1920 applies a clearcoat layer to the last formed basecoat layer.

At 2108, the control module 1920 may determine whether another clearcoat layer is to be applied. If yes, operation 2106 is performed, otherwise operation 2110 is performed.

At 2110, the control module 1920 may determine whether to form one or more tie layers. If yes, operation 2112 is performed, otherwise operation 2124 is performed.

At 2112, the control module 1920 may determine whether to pretreat the paint substrate. If yes, operation 2114 is performed, otherwise operation 2116 is performed.

At 2114, the control module 1920 pretreats the paint substrate, as described above. At 2116, the control module 1920 applies a precursor layer on the pretreatment layer or, if not pretreated, the paint substrate.

At 2118, the control module 1920 may determine whether to form an epoxy based thermoset layer to the precursor layer. If yes, operation 2120 is performed, otherwise operation 2122 is performed. At 2120, the control module 1920 applies the epoxy based thermoset layer to the precursor layer.

At 2122, the control module 1920 moves the resultant paint film with the formed tie layer(s) to the paint film applying station. At 2124, the control module 1920 moves the resultant paint film without tie layers to the paint film applying station. The method may end subsequent to operations 2122, 2124.

The above-described operations of FIGS. 20-21 are meant to be illustrative examples. The operations may be performed sequentially, synchronously, simultaneously, continuously, during overlapping time periods or in a different order depending upon the application. Also, any of the operations may not be performed or skipped depending on the implementation and/or sequence of events.

The above-described examples include fast processing technologies for high-strength automotive-grade carbon-fiber panels together with high-quality paint film coatings being applied in-mold to achieve high-quality paint finishes on parts, such as panels. In an embodiment, the molding process uses a single molding tool and takes 20 minutes or less in cycle time, without requiring a subsequent autoclave process and without requiring any additional painting and/or polishing processes.

The examples include combining two manufacturing processes, compression molding and film-over-part (FOP) application into one operation. This operation includes forming a part with a paint film directly in a compression mold. This reduces the amount of capital equipment needed (i.e., elimination of FOP machine and/or a paint booth for the part), which reduces the manufacturing footprint needed to manufacture the finished painted part. Multiple carbon fiber pre-impregnated plies are molded together with a fast-cure thermoset resin and a compatible paint film layer by a compression molding process to form and cure the part with a finished painted surface. The part may have a predetermined geometry associated with, for example, a body panel of a vehicle.

The examples enable custom-designed blanks with material properties directionally aligned as needed by precise carbon-fiber layer orientations to any requested angles and in any combination of layer stackup sequence. The term “blanks” referring to carbon fiber prepreg plies. The examples enable flexible production of different blanks including sizing the layers, including a selected number of layers, and orientating and ordering the layers in a selected sequence. The resulting stack may be heated, pressed, formed, and finished in one machine (or press) with a batch size of one. This reduces cycle time and enables high volume production.

The examples provide high-speed in-mold co-curing of a part (or panel) structural layers and a paint film having a tie layer (or adhesive) without a subsequent autoclave process. High-strength fast-cure epoxy thermoset structural resins are used with in-mold cure time of less than 20 minutes. The disclosed methods provide, after curing, a completed part that is ready to be assembled on a vehicle without requiring subsequent operations such as trimming, painting, and polishing. The complete part may be assembled onto a space-time frame vehicle.

The disclosed examples enable custom-designed carbon-fiber blanks with material properties directionally aligned by precise carbon-fiber layer orientations to any required angle and in any sequential order of layer orientations via a part formation system (or automated ply stacking, cutting, and curing system). In this system, multiple unidirectional or pre-woven carbon fiber prepreg layers are stacked and cut such that different layers having different orientations are arranged and ordered to achieve quasi-isotropic material strength and performance. This system enables flexible production of different blanks (size, number of layers, orientation sequence) in one or more stations with batch size of one. The system also reduces cycle time, through automation, which enables high volume production.

The part formation system includes material catching and feeding devices and robots that are able to catch an edge of a ply roll after the roll was previously cut off, and then feeding the material to a gripper of a pulling robot. The system further includes the pulling robot for gripping and pulling the ply (or material) from a ply roll over a stacking platform (or table of a mobile robot). The system further includes a mobile robot-based stacking table with a lifting mechanism and a mobile robot omnidirectional driving mechanism that enables plies to be stacked in different orientations (e.g., 0°, 45°, −45°, 90°). As an alternative, a stacking table of a robot of a linear motion system (e.g., rail guided motion system) is implemented. An overhead vision guidance system tracks edges and/or boundaries of layers of stacks for a control module to determine and program cutting paths. An overhead gantry mounted programmable cutting system (e.g., laser cutter) cuts the layers from ply rolls and trims outlines of the layers to pre-defined part shapes.

The lifter mechanism is configured to move a stack vertically after each new layer is added to the stack. A portion of a press mechanism presses the new layer down onto the stack and then lifts away, and the lifter mechanism adjusts height of the table for a next layer to be pulled over and disposed on the stack. A roller of a rolling mechanism may alternatively be used to roll over each new layer to press down the new layer onto the stack. Afterwards, the roller is lifted away, and the stacking table lifter mechanism lowers the table such that another layer can be pulled over and disposed on the stack.

The examples enable: micro/mini-factory design for low volume vehicle production without traditional paint shop infrastructure; a sustainable coating process that has no oven, no sludge tank, and no emissions; and reduced processing time of a fully cured, in-mold paint-film coated, high-strength, carbon-fiber panels with Class A surface quality and durability.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A part formation system comprising:
a mobile robot;
a first material feeding device configured to feed carbon fiber prepreg material, one layer at a time, onto the mobile robot to form a stack of carbon fiber prepreg layers on the mobile robot;
a second material feeding device configured to feed a paint film onto the stack of carbon fiber prepreg layers to provide a resultant stack of layers; and
a heat press configured to form and cure the resultant stack of layers to provide a resultant painted part by heating and compressing the resultant stack of layers.

2. The part formation system of claim 1, wherein the mobile robot is configured to rotate and adjust orientation of the carbon fiber prepreg layers when laid such that the carbon fiber prepreg layers are in different orientations relative to a material feed direction of the first material feed device.

3. The part formation system of claim 1, wherein:
the mobile robot comprises a table; and
the table is configured, prior to each application of the carbon fiber prepreg material, to rotate and adjust orientation of a current stack of carbon fiber prepreg layers such that the carbon fiber prepreg layers of the stack of carbon fiber prepreg layers are laid in different orientations relative to a material feed direction of the first material feed device.

4. The part formation system of claim 1, wherein at least one of the mobile robot and a table of the mobile robot is configured to rotate such that at least one of the carbon fiber prepreg layers is in each of 0°, 45°, 90°, −45° orientations.

5. The part formation system of claim 1, further comprising a laser cutter configured to cut each of the carbon fiber prepreg layers when laid and prior to another layer being stacked on that carbon fiber prepreg layer.

6. The part formation system of claim 1, further comprising:
one or more overhead cameras configured to detect a perimeter of one of the carbon fiber prepreg layers;
a laser cutter; and
a control module configured to control the laser cutter to cut another one of the carbon fiber prepreg layers or the paint film based on the detected perimeter.

7. The part formation system of claim 1, wherein the mobile robot is configured to adjust a height of a table of the mobile robot prior to the stacking of each one of the carbon fiber prepreg layers.

8. The part formation system of claim 1, further comprising a gripper robot configured to pull at least one of the carbon fiber prepreg material and the paint film onto the mobile robot.

9. The part formation system of claim 1, further comprising at least one of a stamper and a press configured, each time a respective one of the carbon fiber prepreg layers is stacked, to apply pressure to flatten and remove air below the respective one of the carbon fiber prepreg layers.

10. The part formation system of claim 1, further comprising a roller configured, each time a respective one of the carbon fiber prepreg layers is stacked, to roll over and apply pressure on and remove air below the respective one of the carbon fiber prepreg layers.

11. The part formation system of claim 1, wherein the paint film comprises a tie layer, the tie layer aiding in bonding the paint film to the stack of carbon fiber prepreg layers when heated and compressed in the heat press.

12. A method of forming a part, the method comprising:
stacking a plurality of carbon fiber prepreg layers to form a first stack on a mobile robot;
disposing a paint film on the first stack to provide a resultant stack;
moving the resultant stack into a heat press; and
heating and compression molding the resultant stack to provide the part having a painted surface as a result of heating and compressing the paint film along with the carbon fiber prepreg layers.

13. The method of claim 12, further comprising:
feeding via a first material feeding device in a first station layers of carbon fiber prepreg material, one layer at a time, onto the mobile robot to form the first stack on the mobile robot;
moving the mobile robot from the first station to a second station; and
feeding via a second material feeding device in the second station the paint film onto the first stack to provide the resultant stack.

14. The method of claim 13, further comprising at least one of rotating the mobile robot or a table of the mobile robot to orient the carbon fiber prepreg layers in different orientations relative to a material feed direction of carbon fiber prepreg material used to form the carbon fiber prepreg layers.

15. The method of claim 12, further comprising:
pretreating a paint substrate of the paint film to provide a pretreated surface;
applying one or more precursors across the pretreated surface of the paint film to deposit a tie layer; and
disposing the paint film including the tie layer on the first stack prior to the resultant stack being placed in the heat press.

16. The method of claim 15, further comprising:
applying an epoxy based thermoset layer on the tie layer; and
disposing the paint film including the tie layer and the epoxy based thermoset layer on the first stack prior to the resultant stack being placed in the heat press.

17. The method of claim 15, wherein at least one of the pretreating and the applying of the one or more precursors is implemented using atmospheric pressure plasma enhanced deposition.

18. The method of claim 12, further comprising cutting each of the carbon fiber prepreg layers when laid and prior to another layer being stacked on that carbon fiber prepreg layer.

19. The method of claim 12, further comprising:
detecting a perimeter of one of the carbon fiber prepreg layers via one or more overhead cameras; and
cutting another one of the carbon fiber prepreg layers or the paint film based on the detected perimeter.

20. The method of claim 12, further comprising at least one of:
each time a respective one of the carbon fiber prepreg layers is stacked, applying pressure to flatten and remove air below the respective one of the carbon fiber prepreg layers; and
each time a respective one of the carbon fiber prepreg layers is stacked, rolling over and applying pressure on and removing air below the respective one of the carbon fiber prepreg layers.
